(19) United States
(12) Patent Application Publication
(10) Pub. No.: US 2014/0095718 A1
(43) Pub. Date: Apr. 3, 2014

(54) MAXIMIZING RESOURCES IN A MULTI-APPLICATION PROCESSING ENVIRONMENT

(71) Applicant: INTERNATIONAL BUSINESS MACHINES CORPORATION, Armonk, NY (US)

(72) Inventors: David M. Daly, Croton-on-Hudson, NY (US); Jose E. Moreira, Irvington, NY (US); Patricia M. Sagmeister, Adliswil (CH); Jessica H. Tseng, Fremont, CA (US)

(73) Assignee: INTERNATIONAL BUSINESS MACHINES CORPORATION, Armonk, NY (US)

(21) Appl. No.: 13/644,756

(22) Filed: Oct. 4, 2012

Related U.S. Application Data
(63) Continuation of application No. 13/630,382, filed on Sep. 28, 2012.

(51) Int. Cl. G06F 15/173

(52) U.S. Cl. 709/226

(57) ABSTRACT

Aspects of the present invention provide a solution for maximizing server site resources in a server network. In an embodiment, an application signature is collected for an application. This application signature includes a representation of operating characteristics of the application. The application signature is compared with application signatures collected from other applications in the server network. Based on the comparison, the application is assigned for execution to a server site that hosts a group of applications that have similar application signatures to that of the application.

### CROSS-REFERENCE TO RELATED APPLICATIONS

This application is a continuation of currently pending U.S. patent application Ser. No. 13/630,382 filed on Sep. 28, 2012. The application identified above is incorporated herein by reference in its entirety for all that it contains in order to provide continuity of disclosure.

### TECHNICAL FIELD

The subject matter of this invention relates generally to application processing. More specifically, aspects of the present invention provide a solution for maximizing resources in a multi-application processing environment.

### BACKGROUND

Computer applications are pieces of computer software that help a user thereof perform a task or a number of related tasks. In the electronic environment of today, these applications are often provided in such a way as to be accessible to a number of users. To accomplish this, a provider of the application may host the application from a particular location that is accessible via a network, such as a local area network or wide area network, such as the Internet.

As the number of users utilizing applications provided by a host increases, the hardware requirements can easily move beyond what is able to be provided by a single server site. Because of this, networks of server sites are often used for purposes of application hosting. These networks can include large numbers of servers that can be geographically remote from one another. One such solution for such a network is a cloud environment. Cloud computing delivers hardware and/or software computing resources for use as a service over a network, such as the internet.

### SUMMARY

The inventors of the present invention have discovered that the current way of managing resources in a network of server sites can be improved. Specifically, applications are often assigned to server sites that fail to maximize resources of the server site. These assignments can use such assigning strategies as first come first served, geographical location, most available space, or the like. However, use of these and other potentially inefficient strategies can result in fewer applications being able to be provided by a specific server site and/or by the network as a whole.

In general, aspects of the present invention provide a solution for maximizing server site resources in a server network. In an embodiment, an application signature is collected for an application. This application signature includes a representation of operating characteristics of the application. The application signature is compared with application signatures collected from other applications in the server network. Based on the comparison, the application is assigned for execution to a server site that hosts a group of applications that have similar application signatures to that of the application.

A first aspect of the invention provides a method for maximizing server site resources in a server network, comprising: collecting an application signature of an application, the application signature including a representation of operating characteristics of the application; comparing the application signature with application signatures collected from other applications in the server network; and assigning, based on the comparing, the application for execution on a server site hosting a group of applications having application signatures that are similar to the application signature of the application.

A second aspect of the invention provides a system for maximizing server site resources in a server network, comprising at least one computer device that performs a method, comprising: collecting an application signature of an application, the application signature including a representation of operating characteristics of the application; comparing the application signature with application signatures collected from other applications in the server network; and assigning, based on the comparing, the application for execution on a server site hosting a group of applications having application signatures that are similar to the application signature of the application.

A third aspect of the invention provides a computer program product stored on a computer readable storage medium, which, when executed performs a method for maximizing server site resources in a server network, comprising: collecting an application signature of an application, the application signature including a representation of operating characteristics of the application; comparing the application signature with application signatures collected from other applications in the server network; and assigning, based on the comparing, the application for execution on a server site hosting a group of applications having application signatures that are similar to the application signature of the application.

A fourth aspect of the invention provides a method for deploying an application for maximizing server site resources in a server network, comprising: providing a computer infrastructure being operable to: retrieve collect an application signature of an application, the application signature including a representation of operating characteristics of the application; compare the application signature with application signatures collected from other applications in the server network; and assign, based on the comparing, the application for execution on a server site hosting a group of applications having application signatures that are similar to the application signature of the application.

Still yet, any of the components of the present invention could be deployed, managed, serviced, etc., by a service provider who offers to implement the teachings of this invention in a computer system.

Embodiments of the present invention also provide related systems, methods and/or program products.

### BRIEF DESCRIPTION OF THE DRAWINGS

These and other features of this invention will be more readily understood from the following detailed description of the various aspects of the invention taken in conjunction with the accompanying drawings in which:

FIG. 1 shows an illustrative computer system according to embodiments of the present invention.

FIG. 2 shows a network environment according to embodiments of the invention.

FIG. 3 shows an application run on a virtual server according to embodiments of the invention.

FIG. 4 shows a table of application signatures according to embodiments of the invention.

FIG. 5 shows example graphical representation of signature comparison according to embodiments of the invention.

FIG. 6 shows an example flow diagram according to embodiments of the invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION

As indicated above, aspects of the present invention provide a solution for maximizing server site resources in a server network. In an embodiment, an application signature is collected for an application. This application signature includes a representation of operating characteristics of the application. The application signature is compared with application signatures collected from other applications in the server network. Based on the comparison, the application is assigned for execution to a server site that hosts a group of applications that have similar application signatures to that of the application.

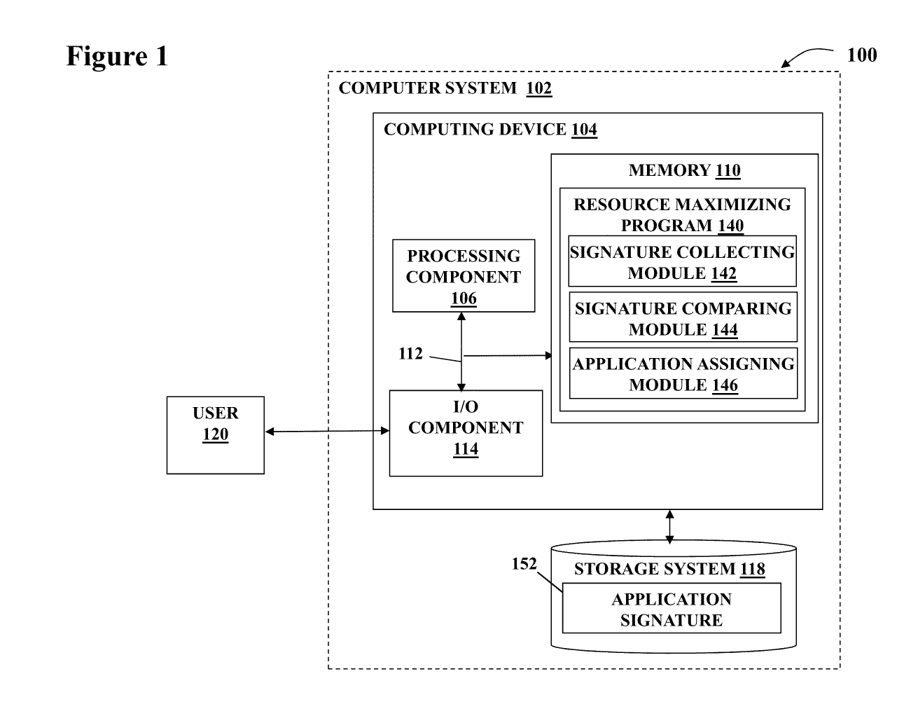

Turning to the drawings, FIG. 1 shows an illustrative environment 100 for maximizing server site resources. To this extent, environment 100 includes a computer system 102 that can perform a process described herein in order to maximize server site resources. In particular, computer system 102 is shown including a computing device 104 that includes a resource maximizing program 140, which makes computing device 104 operable to maximize server site resources by performing a process described herein.

Computing device 104 is shown including a processing component 106 (e.g., one or more processors), a memory 110, a storage system 118 (e.g., a storage hierarchy), an input/output (I/O) component 114 (e.g., one or more I/O interfaces and/or devices), and a communications pathway 112. In general, processing component 106 executes program code, such as resource maximizing program 140, which is at least partially fixed in memory 110. To this extent, processing component 106 may comprise a single processing unit, or be distributed across one or more processing units in one or more locations.

Memory 110 also can include local memory, employed during actual execution of the program code, bulk storage (storage 118), and/or cache memories (not shown) which provide temporary storage of at least some program code in order to reduce the number of times code must be retrieved from bulk storage 118 during execution. As such, memory 110 may comprise any known type of temporary or permanent data storage media, including magnetic media, optical media, random access memory (RAM), read-only memory (ROM), a data cache, a data object, etc. Moreover, similar to processing component 116, memory 110 may reside at a single physical location, comprising one or more types of data storage, or be distributed across a plurality of physical systems in various forms.

While executing program code, processing component 106 can process data, which can result in reading and/or writing transformed data from/to memory 110 and/or I/O component 114 for further processing. Pathway 112 provides a direct or indirect communications link between each of the components in computer system 102. I/O component 114 can comprise one or more human I/O devices, which enable a human user 120 to interact with computer system 102 and/or one or more communications devices to enable a system user 120 to communicate with computer system 102 using any type of communications link.

To this extent, resource maximizing program 140 can manage a set of interfaces (e.g., graphical user interface(s), application program interface, and/or the like) that enable human and/or system users 120 to interact with resource maximizing program 140. Users 120 could include system administrators who want to maximize the resources of their server sites, among others. Further, resource maximizing program 140 can manage (e.g., store, retrieve, create, manipulate, organize, present, etc.) the data in storage system 118, including, but not limited to one or more application signatures 152, using any solution.

In any event, computer system 102 can comprise one or more computing devices 104 (e.g., general purpose computing articles of manufacture) capable of executing program code, such as resource maximizing program 140, installed thereon. As used herein, it is understood that “program code” means any collection of instructions, in any language, code or notation, that cause a computing device having an information processing capability to perform a particular action either directly or after any combination of the following: (a) conversion to another language, code or notation; (b) reproduction in a different material form; and/or (c) decompression. To this extent, resource maximizing program 140 can be embodied as any combination of system software and/or application software. In any event, the technical effect of computer system 102 is to provide processing instructions to computing device 104 in order to maximize server site resources.

Further, resource maximizing program 140 can be implemented using a set of modules 142-146. In this case, a module 142-146 can enable computer system 102 to perform a set of tasks used by resource maximizing program 140, and can be separately developed and/or implemented apart from other portions of resource maximizing program 140. As used herein, the term “component” means any configuration of hardware, with or without software, which implements the functionality described in conjunction therewith using any solution, while the term “module” means program code that enables a computer system 102 to implement the actions described in conjunction therewith using any solution. When fixed in a memory 110 of a computer system 102 that includes a processing component 106, a module is a substantial portion of a component that implements the actions. Regardless, it is understood that two or more components, modules, and/or systems may share some/all of their respective hardware and/or software. Further, it is understood that some of the functionality discussed herein may not be implemented or additional functionality may be included as part of computer system 102.

When computer system 102 comprises multiple computing devices 104, each computing device 104 can have only a portion of resource maximizing program 140 fixed thereon (e.g., one or more modules 142-146). However, it is understood that computer system 102 and resource maximizing program 140 are only representative of various possible equivalent computer systems that may perform a process described herein. To this extent, in other embodiments, the functionality provided by computer system 102 and resource maximizing program 140 can be at least partially implemented by one or more computing devices that include any combination of general and/or specific purpose hardware with or without program code. In each embodiment, the hardware and program code, if included, can be created using standard engineering and programming techniques, respectively.

Regardless, when computer system 102 includes multiple computing devices 104, the computing devices can communicate over any type of communications link. Further, while performing a process described herein, computer system 102 can communicate with one or more other computer systems using any type of communications link. In either case, the communications link can comprise any combination of various types of wired and/or wireless links; comprise any combination of one or more types of networks; and/or utilize any combination of various types of transmission techniques and protocols.

As discussed herein, resource maximizing program 140 enables computer system 102 to maximize server site resources. To this extent, resource maximizing program 140 is shown including a signature collecting module 142, a signature comparing module 144, and an application assigning module 146.

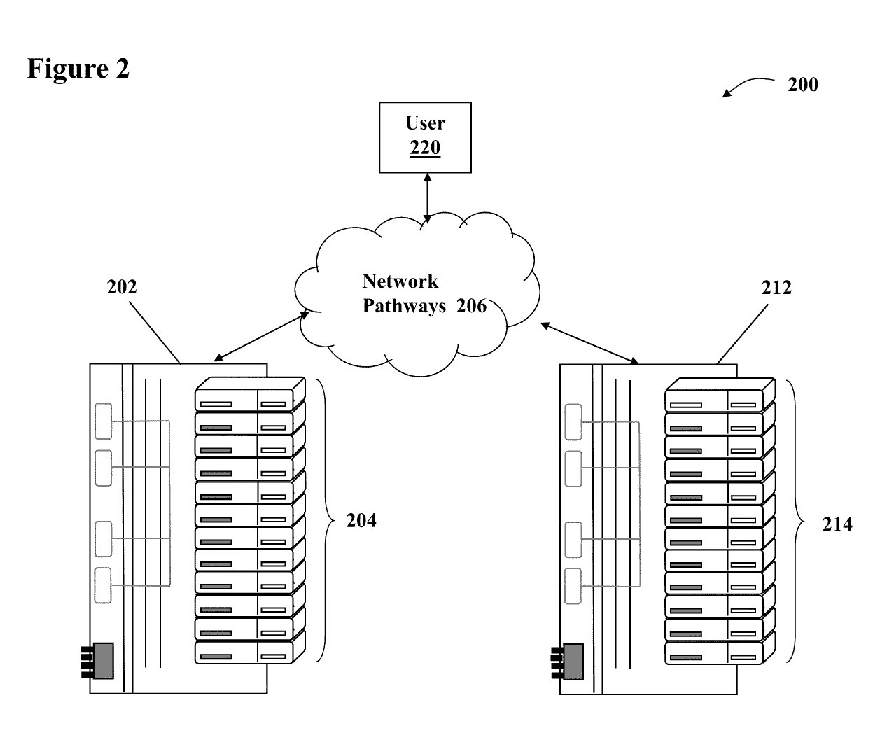

Referring now to FIG. 2, an example server network environment 200 according to embodiments of the invention is shown. Server network environment 200 includes a number of server sites 202, 212 that are connected with each other and one or more users 220 via network pathways 206, using any solution. Each of the server sites 202, 212 host a set of applications, which have been assigned to the server sites 202, 212. When a user 220 wishes to perform a task using an application 204, 214, the user 220 is routed to a particular server site 202, 212 on which the application 204, 214 is being hosted. In an embodiment, server network environment can be a virtual datacenter environment. In this embodiment, one or more of server sites 202, 212 is a physical server. Applications 204, 214 on the server sites 202, 212 in a virtual datacenter environment can include one or more virtual servers.

In an embodiment, server network environment 200 can be a virtual datacenter environment. In this embodiment, one or more of server sites 202, 212 is a physical server. Applications 204, 214 on the server sites 202, 212 in a virtual datacenter environment can include one or more virtual servers. Each instance of application 204, 214 that is a virtual server on a particular physical server can operate simultaneously with other systems instances virtual server applications 204, 214 while maintaining independence. This means that each of the instances of applications 204, 214 that include a virtual server operates independently of other virtual server instances and does not share information with other virtual server instances even though the virtual server instances operate on the same physical server. Owing to the characteristics of these virtual server instances, a single physical server site 202, 212 can execute a very large number of virtual server instances concurrently. The independent operation of these virtual server instances ensures that the number of concurrent virtual server instances is only limited by the hardware constraints of physical server site 202, 212.

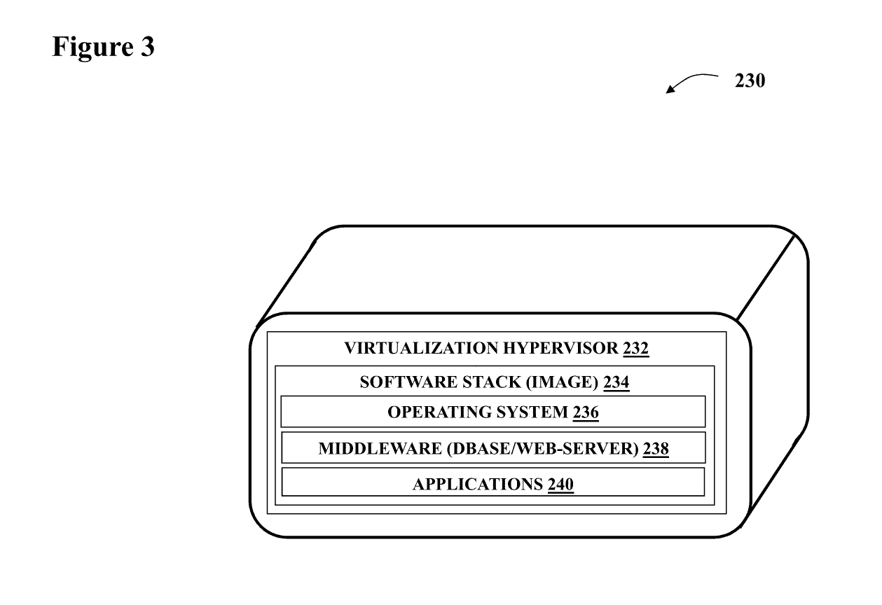

Turning now to FIG. 3, an example virtual server 230 according to embodiments of the invention is shown. It should be understood that virtual server 230 is different from a process virtual machine. A process virtual machine is a platform dependent engine, such as a Java Virtual Machine, that executes platform independent code written in a high-level programming language, such as Java, for performing a specific task (Java and Java Virtual Machine are a trademark of Sun Microsystems in the United States and/or elsewhere). In contrast, the virtual server 230 of the current invention is a virtual system that simulates an entire computing environment. To this extent, rather than performing only a single task, the virtual server 230 of the current invention is an environment within which a variety of tasks, functions, operations, etc., can be carried out by a user 120 (FIG. 1). As such, virtual server 230 can be made to simulate a stand-alone computer system in the eyes of a user 120 (FIG. 1).

To this extent, virtual server 230, includes a virtualization hypervisor 232 at the lowest level. Specifically, virtualization hypervisor 232 provides a platform that allows multiple “guest” systems to run concurrently on the physical server 210 (FIG. 2). To this extent, virtualization hypervisor 232 provides an abstraction level between the hardware level of physical server 210 (FIG. 2) and the higher level software functions of the virtual server 230. In order to provide these software functions, virtual server 230 includes a software stack 234, which can also be referred to as an image. Software stack 234 contains everything that is necessary to simulate a “guest” instance of virtual server 230 on physical server 210 via virtualization hypervisor 232. To this extent, software stack 234 can provide an operating system 236, middleware 238, and processes 240.

In any event, referring back to FIGS. 1 and 2, computer system 102, signature collecting module 142, collects an application signature 152 of an application 204, 214. Application signature 152 includes a representation of operating characteristics of the application. To this extent, application signature 152 can be gathered using any solution now known or later developed, including, but not limited from retrieval from a storage system 118, over a local area or wide area network, or the like, or creation by user 120. This data for this application signature can be gathered based on monitoring functions typical to a server, can be acquired from log results or functions run against the server, can be gathered by agents and/or any other solution now known or later developed for gathering data pertaining to the operation of an application. In an embodiment, application signature 152 can be accumulated using hardware based performance counters that can be gathered by a virtualization hypervisor 232 (FIG. 2) of a virtual machine 230. Application signature 152 gathered in any of these ways can provide an accurate representation of the operation of the application.

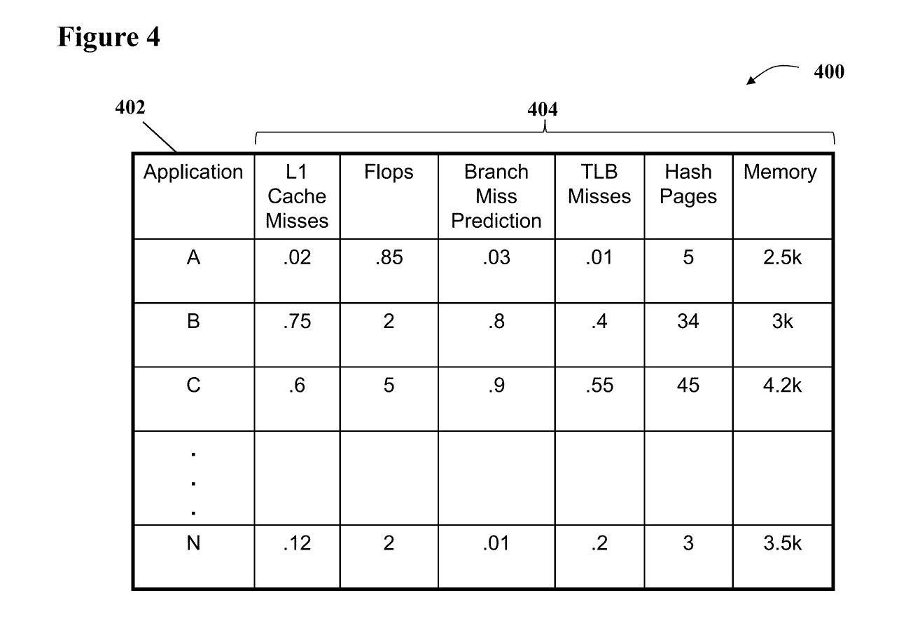

Turning now to FIG. 4, a table containing example application signatures 500 according to an embodiment of the invention is shown. As shown, application signatures 500 includes a list of applications 502 that are being executed in the server network environment 200 (FIG. 2). It should be understood that not all applications 502 being executed in the server network environment 200 (FIG. 2) need be included. Rather, in an embodiment, a subset of the processes being executed on primary site in the server network environment 200 (FIG. 2), such as only those applications requiring a certain amount or type of resource need be included. Application signatures 500 also includes a set of operating characteristics 504. As illustrated, operating characteristics 504 include data indicating a vector of performance counters normalized to instruction count. Such data could include, for example, L1 prefetch misses per instruction, floating point operations (Flops) per instruction, translation lookaside buffer (TLB) misses per instruction, branch mispredicts per instruction, and/or the like. In addition, or in the alternative, operating characteristics 504 could include data indicating a vector of hashes of memory pages used by the application, the amount of memory used, the amount of cache misses, or the like. It should be understood that this list is only meant to be illustrative. Rather, any of the above listed fields in the above list could be omitted and/or other fields could be included. Further, although metric data 400 is illustrated herein in a tabular format, this format should not be taken as limiting. For example, one or more of the application signatures 500 for a particular application could be stored separately and/or in an alternative data structure.

In any event, turning again to FIG. 1, signature comparing module 144, as executed by computer system 102, compare the application signature 152 gathered from the application with other application signatures gathered from other applications. This comparison can be made using any solution for comparing complex data values, such as data vectors, now know or later developed. Based on this comparison, signature comparing module 144 can determine which applications have similar operating characteristics. For example, certain applications, such as highly scientific code, could have a very tight loop of software. An application such as this could have an application signature 152 indicating few instruction cache misses, few branch miss predictions, and a high number of Flops per instruction. In contrast, an application that performs mostly transaction processing, such as a commercial workload could have a large code base, leading to an application signature 152 indicating a large amount of memory, a relatively high number of instruction cache misses, a relative high number of branch mispredicts and a relatively low number of Flops per instruction. On a different level of operation, certain applications could have a small workingset of memory that would need to be accessed during operation. Such applications could have an application signature 152 that indicates a low level 2 cache miss rate and low rate of access to memory. In contrast, an application that streams a large amount of data could have an application signature 152 that indicates a relatively higher number of cache misses because, as it reads each piece of data only once, every action is a cache miss.

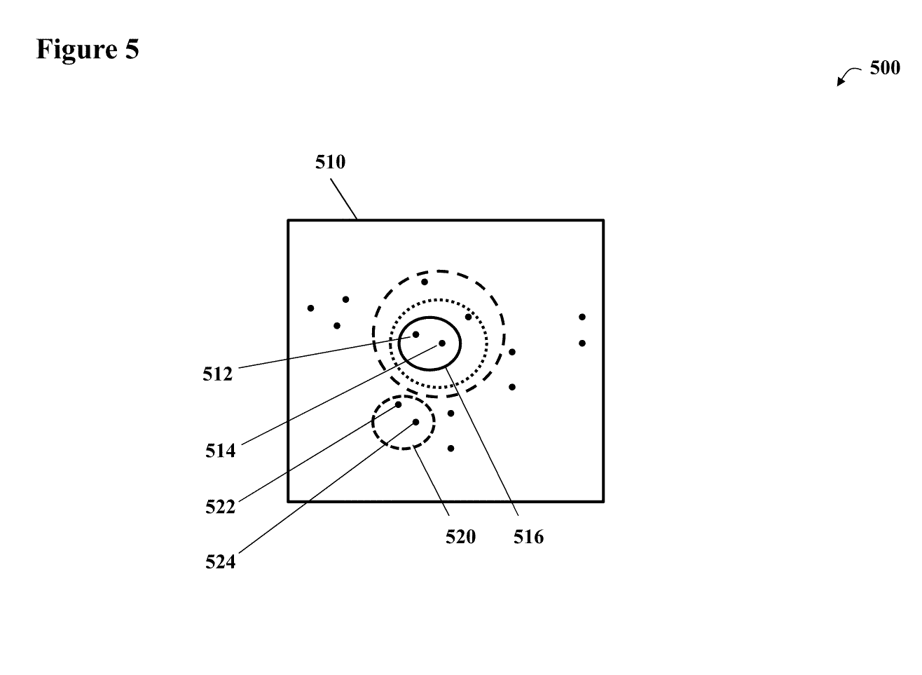

Referring now to FIG. 5, a graphical representation 500 that can be used to compare an application signature 152 (FIG. 1) with a set of other application signatures according to embodiments of the invention is shown. As illustrated, a number of data points that represent application signatures have been represented as a graph 510. Assume that starting data point 512 represents an application signature that the user desires to compare against. Starting data point 512 can be associated 516 with a next proximate data point 514 that is associated with a previously gathered application signature. This associating of the starting data point can be repeatedly performed with each of a series of next proximate previously generated application signatures on the graph 510, as illustrated by the larger circles illustrating the associations. In contrast, an unrelated association 520 to association 516 indicates that a comparison between data points 522 and 524 results in a determination that the application signatures that are associated with these two data points 522 and 524 are related to each other but not to starting data point 512.

Referring back to FIG. 1, application assigning module 146, as executed by computer system 102, can assign an application for execution on a server site based on the comparison performed by signature comparing module 144. Specifically, application assigning module 146 can assign the application to a server site that currently hosts a group of applications having similar applications signatures. This assigning can include assigning the application to one or a plurality of physical servers 202, 214 (FIG. 2) within a server network environment 200. Additionally, or in the alternative, the assigning can include assigning the application to one of a plurality of processors or other divisions within a single server 202, 214 (FIG. 2). Thus, applications that perform similar functions and/or utilize similar resources can be hosted on the same physical server. This physical server can be optimized to more efficiently service the applications hosted thereby. For example, at the physical server level, optimization can take the form of hardware and/or software modifications. For example, the certain processors are designed to enable them to be tuned and/or adjusted. In some cases this tuning may consist adjusting how particular features of the processor behave. This tuning or adjusting may be done by the user for some features, or may be limited to system software for other features. Examples of such processor optimizations could include adjusting the level of threading in the core, or the like. Other examples might include adjusting the cache replacement algorithm (for example to better support streaming execution), and/or setting the hardware stream prefetcher to a less aggressive setting (or off) for a non-streaming workload. Other examples of hardware modifications could include addition of a graphics processor on physical servers having groups of graphic intensive applications, inclusion of special and/or additional floating point processors on physical servers having groups of applications that execute scientific code, and/or the like. In some cases the physical server may be comprised of heterogeneous processing resources. The application can be run on the particular processing resource that is appropriate for it based on its signature.

Additionally or in the alternative, optimization could be performed at the software level. One example of software modifications could include combined hash tables for applications that use the same hash intensive applications. Software level optimization can also include applications on the physical server undergoing a whole or partial de-instantiation. In this process, one or more applications that execute the same application software can be collapsed into a single instance. This can enable a single instance of the application software to be instantiated for all of the collapsed applications. In addition, an application can be checked at the virtual machine level to determine whether a version of application software that it is executing in common with other applications on the physical server is an older version than that being executed by the other members. In this case, attempts can be made to upgrade the software to the most current version, including, but not limiting to contacting a user 120 to offer an upgrade or the like. Once this upgrade has been performed, the application can be merged as described above. The above examples should not be seen as limiting, but it should rather be understood that any solution for optimizing a computer site to perform a certain class of tasks is envisioned.

Further, process virtual machines that are located in different logical partitions (LPAR) of the physical server can be grouped in the same LPAR. In addition, threads of applications that would normally utilize different process virtual machines can be grouped into a single process virtual machine. Still further, LPARs can be converted to WPARs, while remove some of the constraints regarding complete separation of applications while maintaining logical separation.

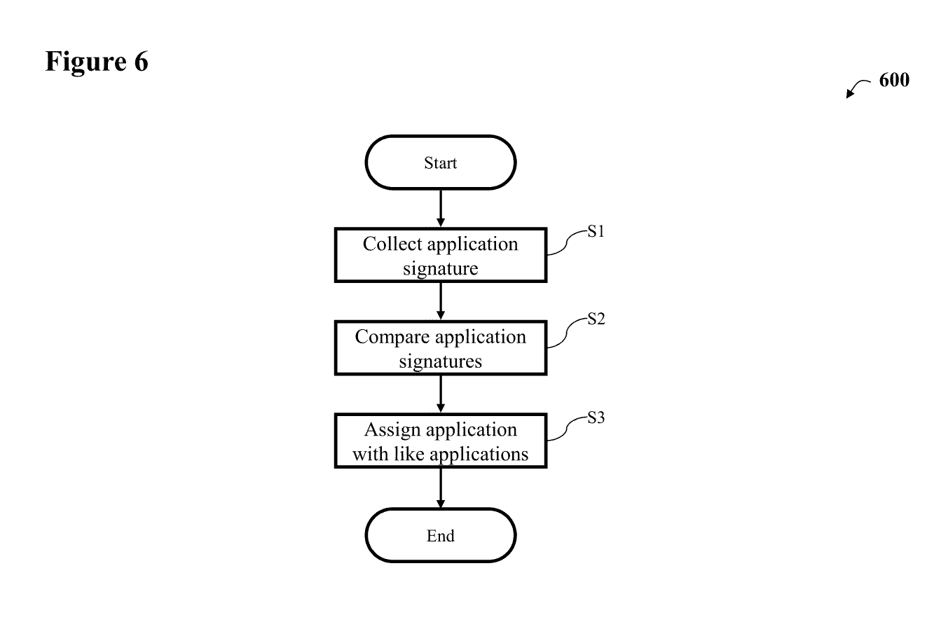

Turning now to FIG. 6, an example flow diagram according to embodiments of the invention is shown. As illustrated in FIG. 6 in conjunction with FIG. 1, in S1, signature collecting module 142, as executed by computer system 102, collects an application signature 152 of an application. Application signature includes a representation of operating characteristics of the application. In S2, signature comparing module 144, as executed by computer system 102, compares application signature 152 with application signatures collected from other applications 204, 214 in the server network 200 (FIG. 2). In S3, application assigning module 146, as executed by computer system 102, assigns the application for execution based on the comparing. This assigning can be performed in such a manner as to group applications having similar application signatures on the same physical server. A physical server having such a group can be optimized to more efficiently perform the functions needed by the applications hosted thereon.

While shown and described herein as a method and system for maximizing server site resources, it is understood that aspects of the invention further provide various alternative embodiments. For example, in one embodiment, the invention provides a computer program fixed in at least one computer-readable medium, which when executed, enables a computer system to maximize server site resources. To this extent, the computer-readable medium includes program code, such as resource maximizing program 140 (FIG. 1), which implements some or all of a process described herein. It is understood that the term “computer-readable medium” comprises one or more of any type of tangible medium of expression, now known or later developed, from which a copy of the program code can be perceived, reproduced, or otherwise communicated by a computing device. For example, the computer-readable medium can comprise: one or more portable storage articles of manufacture; one or more memory/storage components of a computing device; and/or the like.

In another embodiment, the invention provides a method of providing a copy of program code, such as resource maximizing program 140 (FIG. 1), which implements some or all of a process described herein. In this case, a computer system can process a copy of program code that implements some or all of a process described herein to generate and transmit, for reception at a second, distinct location, a set of data signals that has one or more of its characteristics set and/or changed in such a manner as to encode a copy of the program code in the set of data signals. Similarly, an embodiment of the invention provides a method of acquiring a copy of program code that implements some or all of a process described herein, which includes a computer system receiving the set of data signals described herein, and translating the set of data signals into a copy of the computer program fixed in at least one computer-readable medium. In either case, the set of data signals can be transmitted/received using any type of communications link.

In still another embodiment, the invention provides a method of generating a system for remediating a migration-related failure. In this case, a computer system, such as computer system 120 (FIG. 1), can be obtained (e.g., created, maintained, made available, etc.) and one or more components for performing a process described herein can be obtained (e.g., created, purchased, used, modified, etc.) and deployed to the computer system. To this extent, the deployment can comprise one or more of: (1) installing program code on a computing device; (2) adding one or more computing and/or I/O devices to the computer system; (3) incorporating and/or modifying the computer system to enable it to perform a process described herein; and/or the like.

The terms “first,” “second,” and the like, if and where used herein do not denote any order, quantity, or importance, but rather are used to distinguish one element from another, and the terms “a” and “an” herein do not denote a limitation of quantity, but rather denote the presence of at least one of the referenced item. The modifier “approximately”, where used in connection with a quantity is inclusive of the stated value and has the meaning dictated by the context, (e.g., includes the degree of error associated with measurement of the particular quantity). The suffix “(s)” as used herein is intended to include both the singular and the plural of the term that it modifies, thereby including one or more of that term (e.g., the metal(s) includes one or more metals).

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

What is claimed is:

1. A system for maximizing server site resources in a server network, comprising at least one computer device that performs a method, comprising:
collecting an application signature of an application, the application signature including a representation of operating characteristics of the application;
comparing the application signature with application signatures collected from other applications in the server network; and
assigning, based on the comparing, the application for execution on a server site hosting a group of applications having application signatures that are similar to the application signature of the application.

2. The system of claim 1, the method further comprising assigning the application for execution on one of a plurality of processors hosting the group of applications on the server site.

3. The system of claim 1, wherein the collecting occurs while the application is being executed by a virtual machine.

4. The system of claim 1, wherein the application signature includes a vector of performance counters normalized to an instruction count for the application.

5. The system of claim 1, wherein the application signature includes a vector of hashes of memory pages.

6. The system of claim 1, the method further comprising:
subsequent to the assigning, resetting the application signature of the application;
collecting an updated signature for the application;
comparing the updated signature with the application signatures collected from the other applications; and
re-assigning the application based on the results of the comparing.

7. The system of claim 1, the method further comprising optimizing the server site for the group of applications.

8. The system of claim 7, wherein the optimizing further comprises: modifying at least one of a hardware configuration or a software configuration of the server site based on common operating characteristics possessed by the group of applications.

9. The system of claim 7, wherein the optimizing further comprises: sharing an instantiation element of the application with another of the group of applications.

10. The system of claim 9, wherein the instantiation element includes at least one of: grouping multiple instances into a single instance, a moving logical partition (LPARS) to a workload partitions (WPARS), grouping virtual machines (VM) in different LPARS into a single LPAR, or grouping threads in different VMs into a single VM.

11. The system of claim 7, wherein the optimizing further comprises:
determining whether the application is executing an older version of a software product executed in common with members of the grouped application; and
in response to a determination that the application is executing the older version of the software product, facilitating an upgrade of the software product.

12. A computer program product stored on a computer readable storage medium, which, when executed performs a method for maximizing server site resources in a server network, comprising:
collecting an application signature of an application, the application signature including a representation of operating characteristics of the application;
comparing the application signature with application signatures collected from other applications in the server network;
and assigning, based on the comparing, the application for execution on a server site hosting a group of applications having application signatures that are similar to the application signature of the application.

13. The computer program product of claim 12, the method further comprising assigning the application for execution on one of a plurality of processors hosting the group of applications on the server site.

14. The computer program product of claim 12, wherein the collecting occurs while the application is being executed by a virtual machine.

15. The computer program product of claim 12, wherein the application signature includes a vector of performance counters normalized to an instruction count for the application.

16. The computer program product of claim 12, wherein the application signature includes a vector of hashes of memory pages.

17. The computer program product of claim 12, the method further comprising:
subsequent to the assigning, resetting the application signature of the application;
collecting an updated signature for the application;
comparing the updated signature with the application signatures collected from the other applications; and
re-assigning the application based on the results of the comparing.

18. The computer program product of claim 12, the method further comprising optimizing the server site for the group of applications.

19. The computer program product of claim 18, wherein the optimizing further comprises: modifying at least one of a hardware configuration or a software configuration of the server site based on common operating characteristics possessed by the group of applications.

20. The computer program product of claim 18, wherein the optimizing further comprises: sharing an instantiation element of the application with another of the group of applications.

21. The computer program product of claim 20, wherein the instantiation element includes at least one of: grouping multiple instances into a single instance, a moving logical partition (LPARS) to a workload partitions (WPARS), grouping virtual machines (VM) in different LPARS into a single LPAR, or grouping threads in different VMs into a single VM.

22. The computer program product of claim 18, wherein the optimizing further comprises:
determining whether the application is executing an older version of a software product executed in common with members of the grouped application; and
in response to a determination that the application is executing the older version of the software product, facilitating an upgrade of the software product.
